(19) United States
(12) Patent Application Publication
(10) Pub. No.: US 2017/0036254 A1
(43) Pub. Date: Feb. 9, 2017

(54) ROTARY SCRAPING TOOL

(71) Applicant: CHEMGLASS INC., Vineland, NJ (US)

(72) Inventor: THOMAS CAFERRO, ABINGTON, MA (US)

(21) Appl. No.: 15/221,868

(22) Filed: Jul. 28, 2016

Related U.S. Application Data
(60) Provisional application No. 62/200,204, filed on Aug. 3, 2015.

(51) Int. Cl. B08B 9/087; B08B 1/04; B08B 1/00

(52) U.S. Cl. CPC B08B 9/087; B08B 1/005; B08B 1/04

(57) ABSTRACT

A novel, mechanical method and apparatus for scraping desired solids from the interior walls of various vessels, especially spherical glass or metal flasks common to chemical laboratory settings is described. The present invention utilizes spinning, flexible, abrasive tentacles fixed to a vertical shaft. The rotary motion of the vertical shaft is driven by a simple electrical or pneumatic motor. Centrifugal force extends the tentacles, which act as brushes, whereby their abrasive contact with the solids caked to the interior walls effects mechanical scraping. While spinning, the apparatus is moved vertically up and down to effect complete scraping. The present invention, therefore, rapidly removes the majority of dry solid material stuck to the interior of a spherical vessel with a minimum of physical effort. This method provides a significant improvement over the existing standard practice of slow, uncomfortable, manual scraping with spatulas.

### CROSS REFERENCE TO RELATED APPLICATION

This application claims the benefit of Provisional Patent Application Ser. No. 62/200,204, filed Aug. 3, 2015.

### TECHNICAL FIELD

This invention relates to novel, mechanical technologies used to scrape desired, dry solids off the inner walls of various, especially spherical or cylindrical, vessels.

### BACKGROUND OF THE INVENTION

In various modes of the chemical industry, especially synthetic chemistry, crystallization, and reduced pressure drying operations, the desired solids adhere to the inside walls of the vessels used to obtain them. These vessels, especially round-bottomed or spherical and pear-shaped recovery flasks, have narrow openings and large interior surface areas, such that removal of the dry solids by manual scraping, which is most commonly done with a curved metal or Teflon spatula, is slow, inefficient, and uncomfortable to the hands of the chemist. The diameter of the spherical flask is often five to ten times greater than the diameter of the opening of the flask. Furthermore, the desired material often adheres very tenaciously, even to the walls of smooth glass, plastic, or metal vessels. The current commonly used method for removal is by manual scraping with a metal or Teflon spatula.

The method described herein allows for rapid scraping with a minimum of manual effort. While some residual material inevitably remains behind in the vessel, the described method removes as much or more desired material from the interior vessel walls as existing manual methods, only with far less investment of time and physical labor.

It should be emphasized that this method serves to obtain desired, dry material from a vessel. This objective is distinct and different from the complete cleaning or removal of undesired material from a soiled vessel. This objective is also distinct and different from the wet removal or rinsing of desired materials from vessels. The present method is utilized when removal of dry materials needs to be accomplished without changing the dryness of the materials.

While other rotary, mechanically-assisted scraping tools are known in the prior art, the present invention has unique features which make it specifically useful in the recovery of desired solids which are stuck inside a vessel, especially spherical or cylindrical vessels with large diameter and interior surface area relative to a narrow opening.

### SUMMARY OF THE INVENTION

Expandable rotary scraping tools are the subject of prior art. Thompson U.S. Pat. No. 3,958,294; Moen U.S. Pat. No. 4,148,110; and Fusco U.S. Pat. No. 4,183,113, for example, describe elaborate devices with wire-like scraping fingers which extend from a central hub. These devices are of particular use scraping or preparing cylindrical pipes, where access to the interior of said cylinders is facile. Sjoedin U.S. Pat. No. 5,566,666 further developed the flexible rotary scraper with the addition of an elastomeric hub, from which metal scraping fingers extend through molded sleeves to adapt to surfaces with varying contours. Here again the application is scraping surfaces which are relatively accessible. Due to the complexity of their designs, and moreover the large sizes of the central hubs relative to their respective scraping diameters, none of the above devices is suitable for scraping the interior of spherical vessels with large interior surface areas and narrow openings through which the tool is inserted.

Furthermore, Comstock U.S. Pat. No. 3,338,094 describes a rotary paint chipper with flexible chain members. This device features pointed, metallic chipping ends which are unsuitable for scraping glass. In addition, the spinning members of the Comstock paint chipper are partially encased in a solid housing which prevents insertion through the narrow openings of spherical flasks commonly used in synthetic chemistry settings. In further prior art, Festini U.S. Pat. No. 2,254,677 describes a rotary brush with flexible brush elements which could be used to scrape the interior of curved vessels. However, its bulky drum design limits insertion into vessels with narrow openings. The Festini brush design also relies on brush tip contact with the surface to be scraped, which makes this device unsuitable for spherical vessels where the interior diameter varies from bottom to the top of the vessel. Finally, with the Festini device, as with all of the aforementioned prior art, the terminal end of the tool is flat. When inserted into a spherical vessel with a narrow opening such as a round-bottomed flask, none of these tools can effectively scrape materials near the curved bottom of the vessel.

The present invention is, therefore, directed at providing a solvent-free, rotary mechanical method for scraping desired solids from the interior walls of various vessels, especially spherical glass flasks common to chemical laboratory settings. The present invention utilizes spinning, abrasive tentacles fixed to a vertical shaft. The lower end of the shaft is optionally fitted with a soft, preferably Teflon, yet variably grooved or textured tip, which serves not only to protect glass vessels from fracture, but also to effectively scrape the curved bottom of spherical vessels. The rotary motion of the vertical shaft is driven by a simple electrical or pneumatic motor, such as those used in electric drills, mixers, stirrers, and screwdrivers. The tentacled shaft is lowered into the narrow neck of the flask, and then rotated rapidly by motor. Centrifugal force extends the tentacles, which act as brushes, whereby their abrasive contact with the solids caked to the interior walls effects mechanical scraping.

It is notable that the optimal scraping action is not limited to the tips of the tentacles as seen with the devices of Comstock and Festini, but rather the full length of the flexible tentacles are capable of effective scraping. This feature makes this design particularly useful as the diameter of the vessel changes with height such as with spherical vessels. The spinning tentacles flexibly adapt to the shape of the vessel, preventing fracture, while centrifugal motion provides enough incident force to remove adhered solids. While spinning, the apparatus is vertically actuated manually by the operator, or mechanically by a simple gear, rope and pulley, winch, or gear-driven elevator. This vertical motion allows for complete coverage of the interior walls of the vessel by the abrasive tentacles. The scraped material settles naturally in the vessel, and is ideally transferred to a second container if it interferes with the spinning tentacles. After scraped material is transferred, rotary scraping resumes, and this process is repeated until the vast majority of desired dry material has been scraped from the interior vessel walls.

The present invention, therefore, rapidly removes the majority of dry solid material stuck to the interior of a spherical vessel with a minimum of physical effort. This tool provides a significant improvement over the existing standard practice of slow, uncomfortable, manual scraping with spatulas.

One embodiment of the present invention features varying segments of flexible, textured, chain-like material, hereafter referred to as “tentacles”, fixed to a shaft by wire, rivet, ring bolt, or other common fastener. The number of tentacles is preferably two and symmetrically arrayed for spin-balancing, but could number much higher so long as tangling is not a problem. The tentacles have ropelike or chain-like flexibility such that, at rest, insertion in narrow vessel openings is facile, yet the centrifugal reach of the tentacles to the vessel walls provides effective scraping once the rapid revolution about the shaft starts. Chain link tentacles, preferably made of aluminum, hardened polymer plastic, or stainless steel, are textured, durable, relatively inert, and irregular in shape, such that their full length, and not just their tips, enables facile scraping of spherical vessels without damage to the heavy glass walls commonly used in synthetic chemistry laboratory settings.

In another embodiment, the lower tip of the vertical shaft is fitted with a scraping paddle, similar to those commonly used as mechanical stirrers such as available from Chemglass Inc., Catalog #CG-2080. The bottom edge of the scraping paddle is variably curved or straight, depending on the contour of the vessel being scraped. To enable facile insertion of the scraping apparatus into narrow vessel openings, the paddle must be able to rotate on a short axle that is perpendicular, and fixed to, the vertical shaft.

In a preferred embodiment, the lower tip of the shaft is fitted with a sleeve of material which is softer than the rigid, preferably metal, shaft. This fitting, which is preferably made from Teflon, PVC, or hardened rubber, protects the inside of breakable glass vessels. This fitting is further grooved or textured at the lower tip to facilitate scraping of the bottom of the vessel.

All embodiments require a rotary power source to effect scraping, however the nature of the rotary motor varies with the user's needs. For smaller applications, the shaft of the scraping tool is fitted into a handheld rotary motor such as one commonly used for drilling holes, driving screws, stirring, or rotary sanding. The user then manually actuates vertical movement up and down, and in a circular motion where the vessel neck acts as a soft fulcrum, until scraping is complete. For larger applications, rotary motors are supported by a stand or suspended from above. Vertical motion is then achieved mechanically by various but common means, including but not limited to cable and pulley, winch, or gear-driven elevator.

These and other features, aspects, and advantages of the present invention will become better understood with regard to the following description, appended claims, and accompanying drawings.

### BRIEF DESCRIPTION OF THE DRAWINGS

For the purpose of illustrating the invention, there are shown in the accompanying drawings forms which are presently preferred; it being understood that the invention is not intended to be limited to the precise arrangements and instrumentalities shown.

FIG. 1 is a perspective view of a simple shaft with scraping tentacles attached and constructed in accordance with the principles of the present invention;

FIG. 2 is an elevational view of the apparatus in FIG. 1, now inserted in a spherical vessel with solid material adhered to interior walls and with a rotary motor (at rest) is fitted to the top end of the shaft;

FIG. 3 is an elevational view of the apparatus in motion, where the radially spinning tentacles and vertical motion effectively scrape the interior of the vessel;

FIG. 4 is a close up view of the lower tip of the shaft with a semicircular scraping paddle attached via a short axle or pivot point;

FIG. 5 is a close up view of the lower tip of the shaft with a semicircular scraping paddle attached as shown in FIG. 4 and being inserted into the narrow opening of a vessel;

FIG. 6 is a close up view of the lower tip of the shaft with a mushroom shaped fitting attached to the tip and wherein the surface of this fitting is grooved or textured to enable facile scraping at the bottom of a curved vessel, and

FIG. 7 is a close up view of the lower tip of the shaft with a sleeve fitted at the end and wherein the tip of this fitting is grooved or textured to enable facile scraping at the bottom of a curved vessel.

### DETAILED DESCRIPTION OF THE PREFERRED EMBODIMENTS

The following are detailed descriptions of the preferred embodiments of the invention. It is to be understood, however, that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Many of the fastening, connecting, manufacturing, and other means and components utilized in this invention, including the motorized source of rotation, are, per se, widely known. Accordingly, a description of their exact nature, type, or construction is not necessary for a person of ordinary skill in the art or science to understand the invention. Therefore, they will not be discussed in great detail. Furthermore, the various components shown or described herein for any specific application of this invention can be varied or altered and anticipated by this invention, and the practice of a specific application or embodiment of any element may already be widely known or used in the art, by persons skilled in the art or science; therefore, each will not be discussed in significant detail.

The term “desired solid” as used herein refers to any singular substance or mixture of materials that, when dried, adhere to the interior walls of a vessel. Furthermore, desired solids referred to herein are not meant to be washed away, decomposed, or combusted in any way in order to remove them from the vessel. Rather, the desired solids are meant to be recovered intact, with no appreciable changes in chemical composition or dryness. The present invention enables this recovery from the interior of spherical vessels with a minimum of time and physical effort.

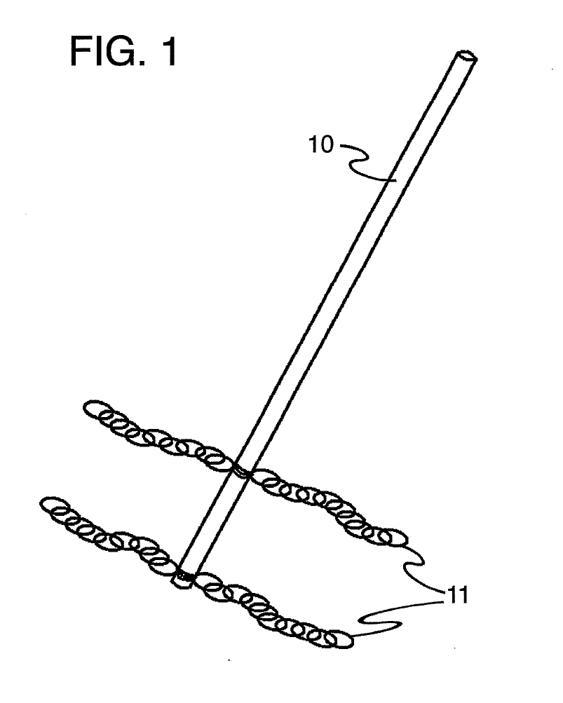

Now referring to the drawings in detail wherein like numbers are used throughout the various drawings to designate like elements, there is shown in FIG. 1 a preferred embodiment of the scraper of the present invention. The scraper includes a cylindrical driveshaft 10 which may have different diameters and lengths to suit various sizes of vessels to be scraped. For the purposes of 0.25-25 L spherical vessels commonly used in the synthetic chemical industry, drive shafts 10 with diameters of 0.6-2.5 cm and lengths of 20-80 cm are preferred. Shaft 10 is preferably made of aluminum, PVC, Teflon, wood, or some combination thereof, but shaft 10 can be made of any relatively rigid and relatively inert material.

Scraping tentacles 11 also are preferably made of aluminum, Teflon, stainless steel, polished stone, or other hard and relatively inert material. They must possess the flexibility of fabric string or chain-link because at rest the apparatus in FIG. 1 must easily be inserted in the narrow opening necks of spherical flasks commonly used in chemical laboratories. The full length of scraping tentacles 11 must also be textured, preferably chain-linked, knotted, or otherwise irregular in shape such that contact with the curved inner vessel walls is both form-fitting and abrasive. This abrasive contact, created as the tentacles revolve rapidly about the driveshaft 10, is essential to the function of the present invention. Equally, the composition of the tentacles is such that high speed contact with vessel walls, even walls composed of glass commonly used in chemical laboratories, does not result in the fracture of vessel walls.

Tentacles 11 are attached to or passed through shaft 10 with wire, screws, rivets, ring bolts, or other common fastener. The fastener is strong enough to hold the tentacles to the shaft while spinning, but they only add minimal width to the apparatus. As with the shaft and tentacles, the fasteners are preferably made of aluminum, Teflon, stainless steel, or otherwise strong but relatively inert material.

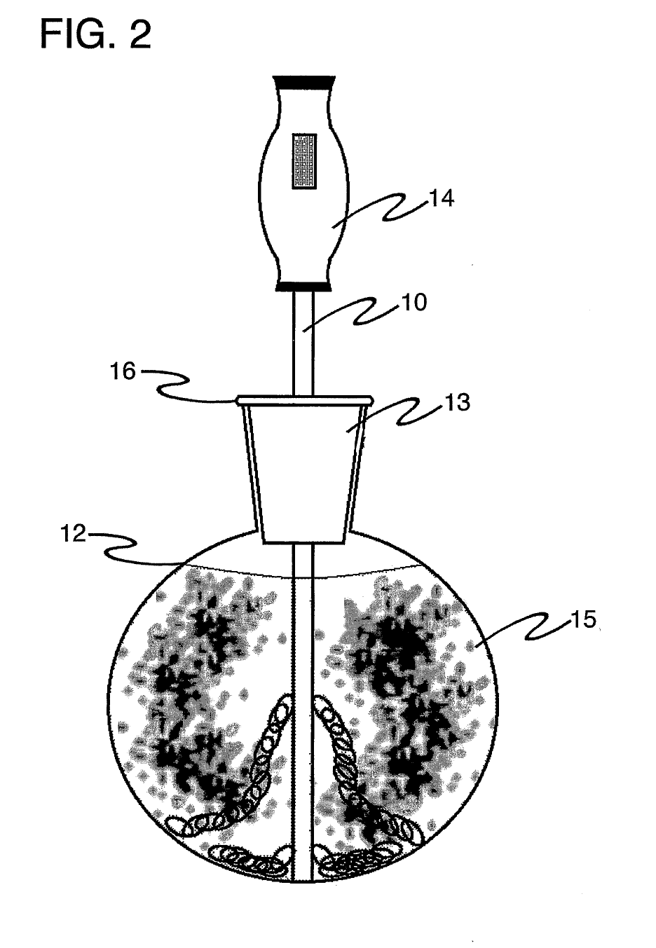

FIG. 2 shows the apparatus in FIG. 1, now lowered through neck 16 into spherical vessel 12, the interior of which is caked with solid material 15. The driveshaft 10 is then fitted with an adapter 13 which is, per se, known in the art and is frequently made of glass or Teflon. While the adapter 13 improves the fit of the shaft in the vessel neck, this sleeved connection between shaft 10 and adapter 13 is essentially frictionless.

Also in FIG. 2, the top end of the driveshaft 10 is fitted with a rotary motor 14. Motors of this type are common in electric drills, rotary sanders, cordless screwdrivers, overhead stirrers, and many other devices. The preferred embodiment of the present invention requires four things of the rotary ‘motor: 1. RPM>500 and preferably 500-1500 rpm; 2. Adjustable fitting or chuck to accommodate shafts of varying diameters; 3. Moderate size, i.e. handheld for smaller scale applications, and 4. Capability to run on standard a/c cord or rechargeable battery. Air driven rotary motors are also acceptable. Rotations in excess of 1800 rpm are generally unnecessary and may generate undesired heat due to friction.

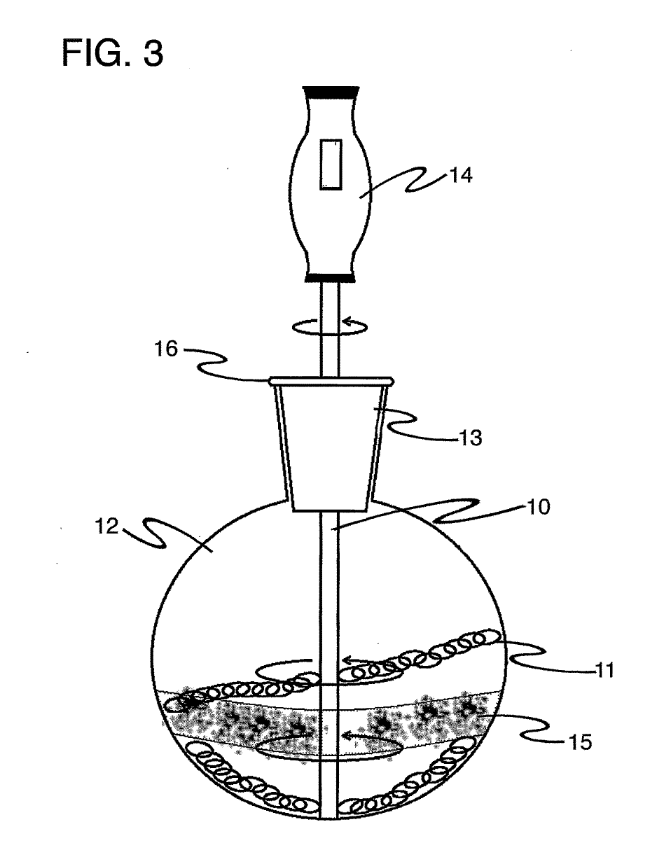

FIG. 3 shows a view of the apparatus similar to FIG. 2, where the rotary motor 14 is now running. The rapid rotation of shaft 10 causes tentacles 11 to extend by centrifugal force. This centrifugal reach puts tentacles 11 in abrasive contact with the desired solid 15. The flexible yet abrasive, chain-like nature of tentacles 11 provides effective scraping contact with the spherical interior walls. The tip to tip length of the extended tentacles 11 must exceed the diameter or width of the vessel 12 at its widest point. The ratio of the overall length of the extended tentacles 11 to the diameter of a spherical or cylindrical vessel 12 is variably 1.1:1 to 2:1, optimally 1.2 to 1.5:1. During operation of the scraping apparatus, the vessel 12 should be secured in one position.

As the revolving tentacles scrape desired solids 15 off the interior walls of the fixed vessel 12, the scraping apparatus is repeatedly raised and lowered in a vertical motion to achieve complete coverage over the majority of the interior if the vessel. If clearance between the adapter 13 and shaft 10 allows, the motor can be moved in a circular or orbital motion, where the adapter 13 acts as a soft fulcrum, to effect better scraping at the bottom of the vessel 12. On smaller scale for vessels ranging from 0.25-10 L, for example, the vertical motion is preferably achieved manually, with common, portable, and easily stowed handheld rotary motors attached to short shafts 10. As scale increases, however, the rotary motors become large and unwieldy, such that they are preferably supported by a stand, side mounted clamp, or an overhead fixture. In this case, the necessary vertical motion is achieved by common mechanical means, including but not limited to cable and pulley, winch, or gear-driven elevator.

It is notable that as the desired solid 15 is effectively scraped as depicted in FIG. 3, said solids naturally settle in the bottom of the vessel. The motion of the scraping tentacles grinds the liberated solids into desirable small, and relatively uniform particles. However, the settled solids can interfere with the further removal of material near the bottom of the vessel. To remedy this, the dry, scraped solids should be periodically transferred to a second vessel by turning the vessel upside down. Once the settled solids have been poured off, the present invention can be re-inserted, and mechanical scraping resumed.

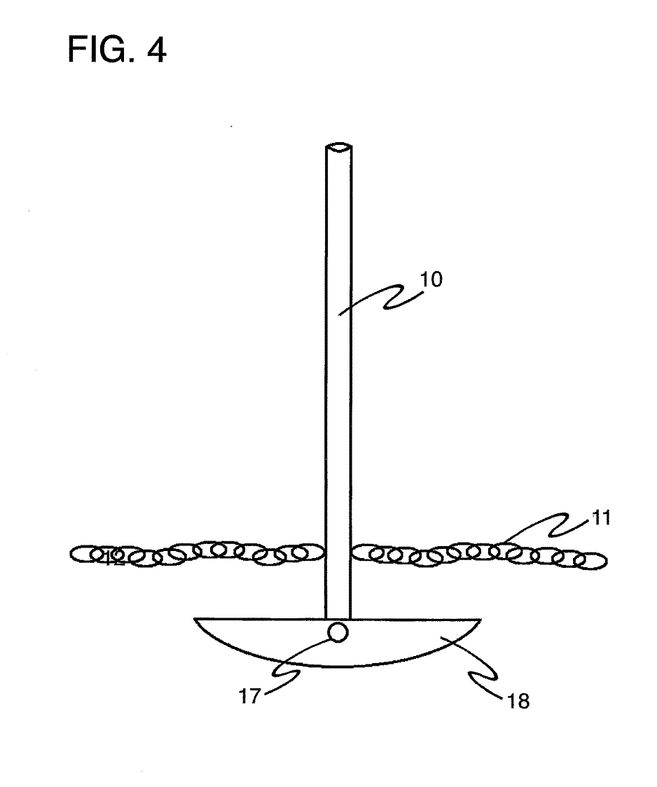

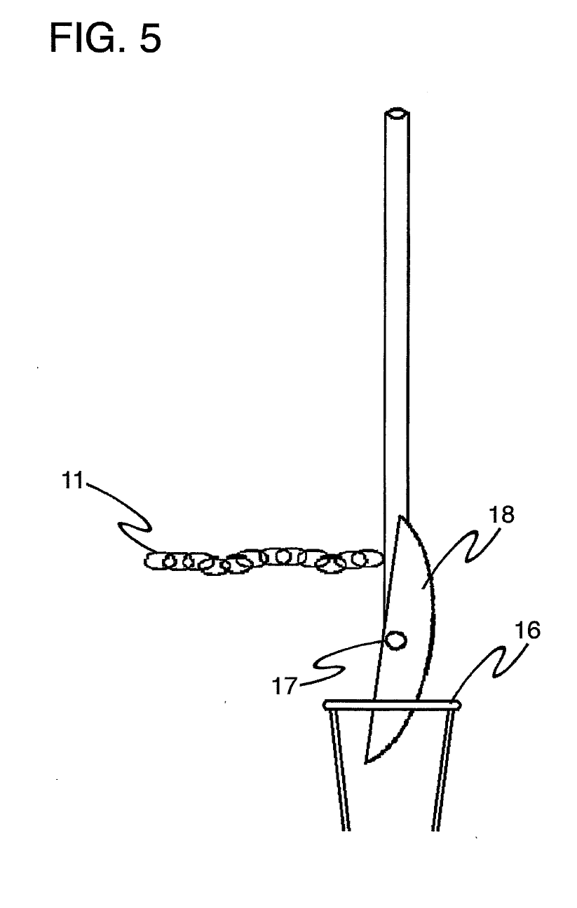

FIGS. 4 and 5 show close up views of another embodiment, where the lower tip of shaft 10 is fitted with a prior art scraping paddle 18 such as the stirring paddle available from Chemglass Inc., Catalog #CG-20g0. The scraping paddle 18 must be fixed upon a horizontal axle or pivot 17 such that the tip of the apparatus can be easily inserted into spherical vessels with narrow necks 16 as shown in FIG. 5. This is a known design previously applied as a mechanical stirrer, though in the present invention this feature is applied for scraping of dry solids. As with other components above, the paddle is preferably made of Teflon, PVC, or other rigid but relatively inert material.

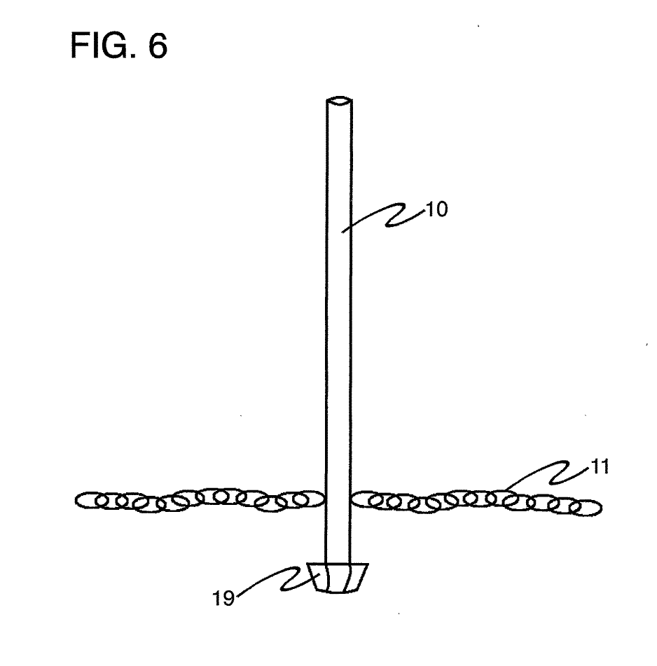

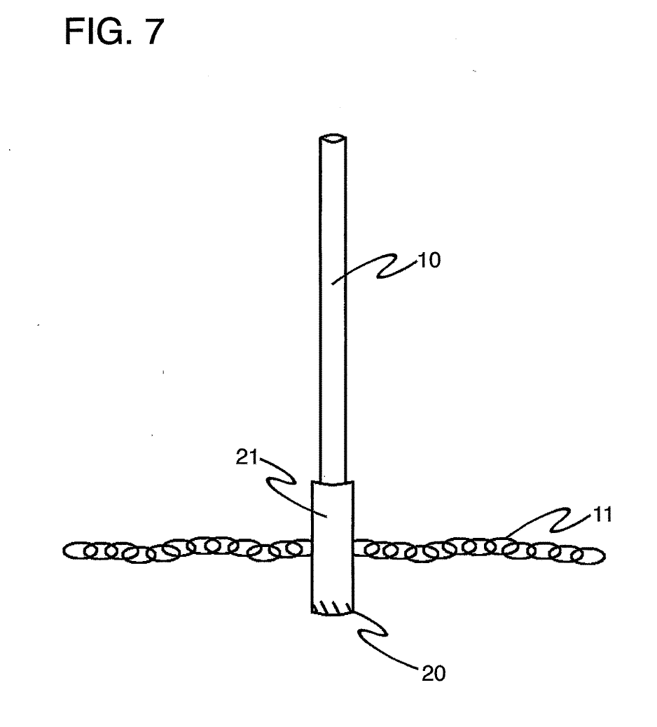

FIGS. 6 and 7 similarly show textured lower tips which are preferable for scraping. These tips vary in structure with the obvious goal of removing dry material from the lower reaches of the flask. The tips 19 and 20 are variably notched, flanged, grooved, or carved such that they cause scraping friction with the vessel walls without causing a fracture. Where the shaft 10 is made of aluminum or other hard metal, tips 19 and 20 and sleeve 21 are preferably made of softer materials, such as PVC, Teflon, or hardened rubber to prevent fracture of the vessel.

The present invention may be embodied in other specific forms without departing from the spirit or essential attributes thereof. For example, a telescoping shaft with the capacity to vary its length can be fitted with interchangeable scraping heads to accommodate spherical vessels of different volume. Accordingly, reference should be made to the appended claims rather than to the foregoing specification as indicating the scope of the invention.

I claim:

1. A tool for scraping desired solids from the interior walls of laboratory-type vessels comprising:
a vertically extending elongated rod, said rod having an upper end and a lower end and having a diameter that is small enough to fit within the open top of the vessel, said rod having a length that allows it to extend from the bottom of the interior of said vessel to the outside of the vessel above the open top;
a first plurality of flexible tentacles attached to said rod adjacent said lower end thereof, said tentacles being connected to said rod and being so constructed and arranged so that said lower end of said rod with said tentacles attached can pass through said open top of said vessel, said tentacles having a length which allows them to contact the inner wall of said vessel, and
motor means attached to said upper end of said rod for rotating said rod at a speed sufficient to cause said tentacles to spin and extend outwardly by centrifugal force to scrape the inside walls of said vessel.

2. The tool as claimed in claim 1 further including a second plurality of flexible tentacles attached to said rod above said first plurality of tentacles, said second plurality of tentacles being connected to said rod and being so constructed and arranged so that said lower end of said rod with said second plurality of tentacles attached can pass through said open top of said vessel, said second plurality of tentacles having a length which allows them to contact the inner wall of said vessel.

3. The tool as claimed in claim 1 wherein said tentacles are chain-like.

4. The tool as claimed in claim 1 further including an additional scraper attached to the lower end of said rod for rotation therewith for scraping the bottom of said vessel.

5. The tool as claimed in claim 4 wherein said additional scraper is pivotally attached to said rod so as to be movable between a first nonworking position wherein it is essentially parallel to said rod and a second working position wherein it essentially perpendicular to said rod.

6. The tool as claimed in claim 1 wherein the length of said rod is adjustable to accommodate vessels of different heights.

7. A method for removing desired solids from the interior walls of laboratory-type vessels comprising the steps of:
providing a tool having a vertically extending elongated rod, said rod having an upper end and a lower end and having a diameter that is small enough to fit within the open top of the vessel, said rod having a length that allows it to extend from the bottom of the interior of said vessel to the outside of the vessel above the open top, said tool further including a first plurality of flexible tentacles attached to said rod adjacent said lower end thereof, said tentacles being connected to said rod and being so constructed and arranged so that said lower end of said rod with said tentacles attached can pass through said open top of said vessel, said tentacles having a length which allows them to contact the inner wall of said vessel;
inserting said lower end of said rod into said vessel and rotating said rod at a speed sufficient to cause said tentacles to spin and extend outwardly by centrifugal force to scrape the inside walls of said vessel, and
moving said tool upwardly and downwardly so that said tentacles scrape substantially the entire inside walls of said vessel.

8. The method as claimed in claim 7 including the steps of removing said tool from said vessel, emptying the solids that had been scraped off of the walls by turning said vessel upside down and then repeating the said scraping step.
